(19) United States
(12) Patent Application Publication
(10) Pub. No.: US 2019/0358933 A1
(43) Pub. Date: Nov. 28, 2019

(54) COMPOSITE OF STAINLESS STEEL AND RESIN, METHOD FOR MANUFACTURING THE SAME

(71) Applicant: Samsung Electronics Co., Ltd., Gyeonggi-do (KR)

(72) Inventors: Asung Kim, Gyeonggi-do (KR); Wooktae Kim, Gyeonggi-do (KR); Sangik Son, Gyeonggi-do (KR); Gyuha Jo, Gyeonggi-do (KR)

(73) Assignee: Samsung Electronics Co., Ltd.

(21) Appl. No.: 16/409,163

(22) Filed: May 10, 2019

(30) Foreign Application Priority Data
May 28, 2018 (KR) 10-2018-0060335

(51) Int. Cl. B32B 15/08; B32B 15/18; B32B 38/10; B32B 3/26; B32B 37/18; C25F 3/06

(52) U.S. Cl. CPC B32B 15/08; B32B 15/18; B32B 38/10; B32B 7/12; B32B 37/182; C25F 3/06; B32B 3/263

(57) ABSTRACT

Composites, methods of manufacturing a composite, and methods of surface treatment of stainless steel are provided. A composite may include stainless steel of which a concave-convex surface is constructed through electrolytic etching, and resin joined to the concave-convex surface.

### CROSS REFERENCE TO RELATED APPLICATION(S)

This application is based on and claims priority under 35 U.S.C. § 119(a) of a Korean Patent Application Serial number 10-2018-0060335, filed on May 28, 2018, in the Korean Intellectual Property Office, the entire disclosure of which is incorporated herein by reference.

### BACKGROUND

### 1. Field

The present disclosure relates generally to a composite of stainless steel and resin, and a manufacturing method thereof.

### 2. Description of Related Art

In various industrial fields relate to manufacturing of automobile parts, household appliances, industrial machines, etc., a technique of joining metal and resin is required, and various adhesive materials have been developed for this purpose. Meanwhile, a simpler joining method without having to use an adhesive material has been studied. There exists a method of putting a metal member into a metal mold, injecting a molten resin to construct a resin member, and joining the resin member and the metal member.

In an effort to increase rigidity or enhance design aspects in portable electronic devices such as smart phones or various other devices, various attempts have been made to manufacture exterior members which utilize stainless steel. When it is intended to join the stainless steel and the resin, it may be difficult to secure a stable bonding force between the stainless steel and the resin due to a material property of the stainless steel.

### SUMMARY

The present disclosure has been made to address at least the disadvantages described above and to provide at least the advantages described below.

In accordance with an aspect of the present disclosure, there is provided a composite. The composite may include stainless steel of which a concave-convex surface is constructed through electrolytic etching and resin joined to the concave-convex surface.

In accordance with an aspect of the present disclosure, there is provided a method of manufacturing a composite. The method may include constructing a concave-convex surface by performing electrolytic etching on stainless steel and joining resin to the concave-convex surface.

In accordance with an aspect of the present disclosure, there is provided a surface treatment method of stainless steel. The surface treatment method may include constructing surface treatment liquid in which sulfuric acid and at least one chlorinated compound are mixed, and performing electrolytic etching on the stainless steel by utilizing the surface treatment liquid. The chlorinated compound has a concentration of about 10˜100 g/L, the sulfuric acid has a concentration of about 50˜300 g/L, and the electrolytic etching utilizes a current density of about 0.5˜5 A/dm2.

### BRIEF DESCRIPTION OF THE DRAWINGS

The above and other aspects, features and advantages of certain embodiments of the disclosure will be more apparent from the following detailed description taken in conjunction with the accompanying drawings, in which:

FIG. 1 is a flowchart of a method of manufacturing a composite of stainless steel and resin, according to an embodiment;

FIG. 2A is a diagram of a base metal, according to an embodiment;

FIG. 2B is a diagram of a solution, according to an embodiment;

FIG. 2C is a diagram of metal treatment, according to an embodiment;

FIG. 3A is a diagram of an electron micrograph, according to an embodiment;

FIG. 3B is a diagram of an electron micrograph, according to an embodiment;

FIG. 3C is a diagram of a graph, according to an embodiment;

FIG. 4 is a diagram of an electron micrograph, according to an embodiment;

FIG. 5A is a diagram of a molding process, according to an embodiment;

FIG. 5B is a diagram of a composite, according to an embodiment; and

FIGS. 6, 7 and 8 are diagrams of an electronic device including a composite of stainless steel and resin, according to an embodiment.

### DETAILED DESCRIPTION

Embodiments of the disclosure will be described herein below with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device indicates different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. Terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the disclosure.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the disclosure may include at least one of an application-specific integrated circuit (ASIC) chip, a field-programmable gate array (FPGA), and a programmable-logic device for performing operations which has been known or are to be developed hereinafter.

An electronic device according to the disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

The electronic device may be a home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

The electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automatic teller machine (ATM) in banks, point of sales (POS) devices in a shop, or an Internet of things (IoT) device (e.g., a light bulb, various sensors, electric or gas meter, a sprinkler device, a fire alarm, a thermostat, a streetlamp, a toaster, a sporting goods, a hot water tank, a heater, a boiler, etc.).

The electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include an electronic device according to the development of new technology.

Hereinafter, an electronic device will be described with reference to the accompanying drawings. In the disclosure, the term “user” indicates a person using an electronic device or a device (e.g., an artificial intelligence electronic device) using an electronic device.

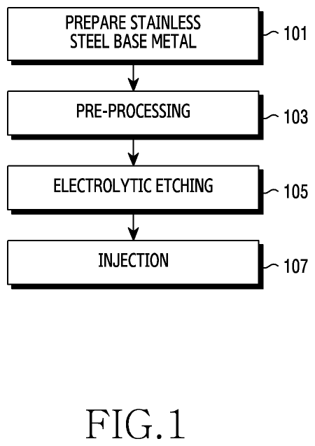

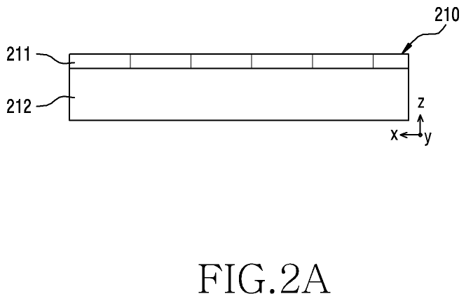

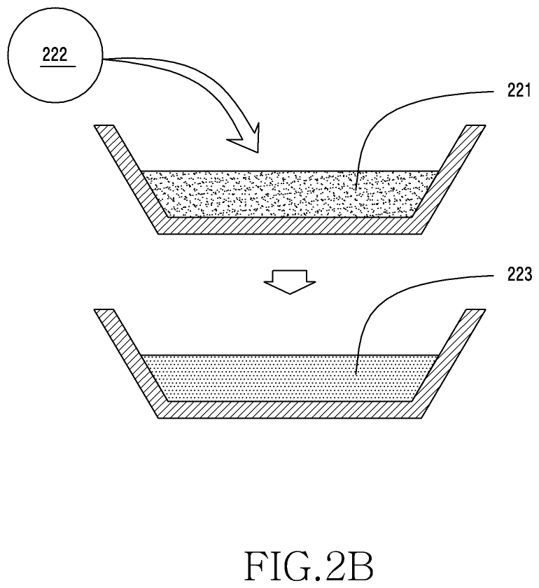

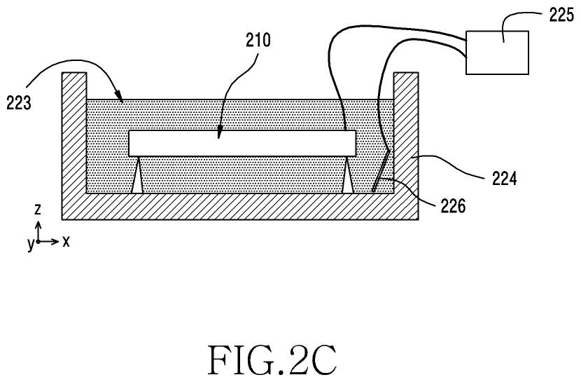

FIG. 1 is a flowchart of a method of manufacturing a composite of stainless steel and resin, according to an embodiment. FIG. 2A is a diagram of a base metal, according to an embodiment.

Referring to FIGS. 1 and 2A, at step 101, a base metal (hereinafter, a stainless steel base metal) 210 including stainless steel may be prepared. The stainless steel base metal 210 may be molded in a desired shape through various schemes such as computer numerical control (CNC), press, die casting, or the like by utilizing stainless steel.

The stainless steel may be alloy steel in which chromium (Cr) is added to iron (Fe) by at least about 12% in order to secure corrosion resistance. The chromium is oxidized to construct a passivity layer 211 of a thin chromium oxide (Cr2O3) on a surface of iron 212. This chromium oxide layer 211 may prevent oxygen from penetrating the iron 212. A thickness of the chromium oxide layer 211 may be about 10˜30 angstroms (Å) or about 20 ˜30 micrometer (um). Although the stainless steel uses iron as a base and the chromium as a primary raw material, in addition to the chromium, the stainless steel may be constructed by further alloying other metallic materials such as nickel (Ni), molybdenum (Mo), nitrogen (N), or the like. In order to improve a physical property such as corrosion resistance, formability, heat resistance, rigidity, ductility, or the like. The stainless steel is classified according to a chemical composition and a metal structure. According to the chemical composition, the stainless steel may be classified into a Fe—Cr type and a Fe—Cr—Ni type. According to the metal structure, the stainless steel may be classified into an Austenite type (e.g., STS304, STS316, STS316L, STS301, STS321, etc.), a Ferrite type (e.g., STS430, STS430J1L, STS409L, etc.), a Martensite type (e.g., STS410, STS420J1L, STS420L2, etc.), a Duplex type (e.g., STS2205, STS2304, STS2507, etc.), and a precipitation hardening type.

Although the stainless steel base metal 210 may be constructed by utilizing STS316L, a variety of other stainless steel may also be utilized.

At step 103, a surface of the stainless steel base metal 210 may be pre-processed. Coolant, debris, fine dust, or the like may be attached to the surface of the mechanically processed stainless steel base metal 210, and the pre-processing may include cleaning for this. The pre-processing may include degreasing for removing greasy contamination attached to the surface of the stainless steel base metal 210. In the degreasing, various stainless steel rinsing materials (e.g., degreaser) which use a surfactant as a main component may be utilized. Acidic degreasing in which an acidic substance and a surfactant are used together may be performed. A processing temperature of the degreasing may be about 20˜80° C., and a processing time of the degreasing may be about 1 to 20 minutes. However, these values may vary depending on a surface state of the stainless steel, a condition of the surfactant, or the like.

The pre-processing may include polishing which utilizes an abrasive in order to planarize an uneven irregular surface of the stainless steel base metal 210.

At step 105, the pre-processed surface of the stainless steel base metal may be subjected to electrolytic etching. The electrolytic etching may be defined as a surface treatment method in which a concave-convex portion is created on the surface of the stainless steel base metal by performing anode processing on the stainless steel base metal through electrolysis, or in which a shape is created by exposing or partially dissolving a crystal structure. When the stainless steel base metal is placed at an anode of a power supply and is electrolyzed in surface treatment liquid, a surface including a concave-convex portion (hereinafter, a concave-convex surface) on which grains and grain boundaries are revealed may be constructed by means of etching in which oxygen generated at the anode of the stainless steel base metal oxidizes the surface of the stainless steel.

FIG. 2B is a diagram of a solution, according to an embodiment. The electrolytic etching of the stainless steel base metal may utilize a variety of surface treatment liquid. Referring to FIG. 2B, at least one chlorinated compound 222 may be added to an aqueous sulfuric acid solution 221 in which sulfuric acid (H2SO4) and water are mixed, thereby constructing surface treatment liquid 223 to be used in the electrolytic etching. Sulfuric acid contained in the surface treatment liquid 223 may have a concentration of about 50˜300 g/L. A chlorinated compound contained in the surface treatment liquid 223 may have a concentration of about 10˜100 g/L.

Various other acid materials such as nitric acid (HNO3) or the like which replaces the sulfuric acid may also be used in the surface treatment liquid.

The chlorinated compound contained in the surface treatment liquid 223 may contain iron chloride (FeCl). The iron chloride may contain ferrous chloride (FeCl2) or ferric chloride (FeCl3). The ferrous chloride may have properties of melting point 672° C., boiling point 1023.4° C., specific gravity 2.99 (at 18° C.), and solubility 68.5 g/100 mL (at 20° C.). The ferric chloride may have properties of melting point 300° C., boiling point 317° C., specific gravity 2.804 (at 20° C.), and solubility 74.4 g/100 mL (at 0° C.). The surface treatment liquid 223 may be constructed to contain other chlorinated compounds to replace the iron chloride, or may be constructed to contain other chlorinated compounds in addition thereto. The chlorinated compound utilized in the surface treatment liquid 223 may contain at least one of sodium chloride (NaCl), aluminum chloride (AlCl3), magnesium chloride (MgCl2), potassium chloride (KCl), and calcium chloride (CaCl2).

FIG. 2C is a diagram of metal treatment, according to an embodiment. Referring to FIG. 2C, the surface treatment liquid 223 may be put in a bath 224, and the stainless steel base metal 210 coupled to a power supply 225 may be immersed in the surface treatment liquid 223. A cathode (or lead cathode) 226 of the power supply 225 may be put in the surface treatment liquid 223 so as not to be in contact with the stainless steel base metal 210. When the stainless steel base metal 210 is used as an anode and is electrolyzed in the surface treatment liquid 223, etching in which oxygen generated in the stainless steel base metal 210 oxidizes a surface of the stainless steel base metal 210 is performed, thereby constructing a concave-convex surface on which grains and grain boundaries are revealed. As such, a surface treatment method in which the stainless steel base metal 210 is subjected to electrolytic etching by utilizing the surface treatment liquid 223 may be defined anode oxidation or anodizing for stainless steel.

The following chemical formula 1 and chemical formula 2 are chemical reaction formulas regarding electrolytic etching of the stainless steel base metal 210 which utilizes the surface treatment liquid 223. The chemical formula 1 represents a chemical reaction formula between iron (Fe) contained in stainless steel and sulfuric acid (H2SO4) of the surface treatment liquid 223 and a chemical reaction formula between iron (Fe) contained in stainless steel and chloride (MCL) of metal M. The chemical formula 2 represents a chemical reaction formula between chromium (Cr) contained in stainless steel and the sulfuric acid (H2SO4) of the surface treatment liquid 223 and a chemical reaction formula between chromium Cr contained in stainless steel and chloride (MCL) of metal M.

Chemical formula 1

Fe+H₂SO₄→FeSO₄+H₂

Fe+MClΔFeCl+M

Chemical formula 2

Cr₂6H₂SO₄→Cr₂(SO₄)₃+3SO₂+6H₂O

Cr+MCl→CrCl+M

The surface of the stainless steel base metal 210 subjected to electrolytic etching may have various grains and grain boundaries depending on a composition and concentration of the surface treatment liquid, a temperature, voltage and/or current of the surface treatment liquid, or the like. Current density utilized in the electrolytic etching may be about 0.5˜5A/dm2. A processing temperature for performing the electrolytic etching may be about 30˜70° C. (e.g., about 60° C.). According to an embodiment, a processing time for performing the electrolytic etching may be about 2 to 20 minutes.

Although not shown in FIG. 1, unnecessary materials (e.g., silicon, etc.) may remain on the surface of the stainless steel base metal as a smut in the form of oxide after the electrolytic etching. Rinsing may be performed to remove the smut by utilizing water or solvent (or rinsing liquid). The smut remaining on the stainless steel surface may be removed by utilizing ultrasonic cleaning A processing temperature for performing the ultrasonic cleaning may be about 20˜60° C., and a processing time for performing the ultrasonic cleaning may be about 3-20 minutes.

Although not shown in FIG. 1, after rinsing such as the ultrasonic cleaning, drying may be performed to remove moisture of the surface of the stainless steel base metal. The drying may utilize air injection. A processing temperature for performing the drying may be about 20˜60° C., and a processing time for performing the drying may be about 3˜20 minutes.

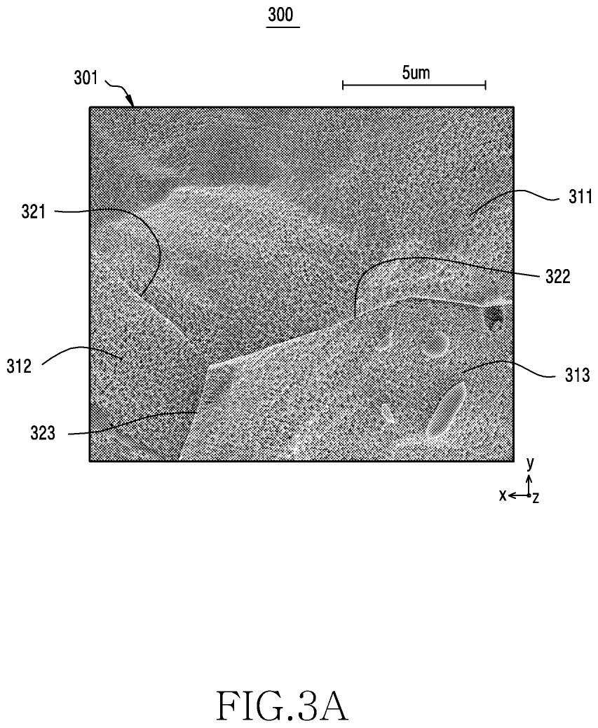

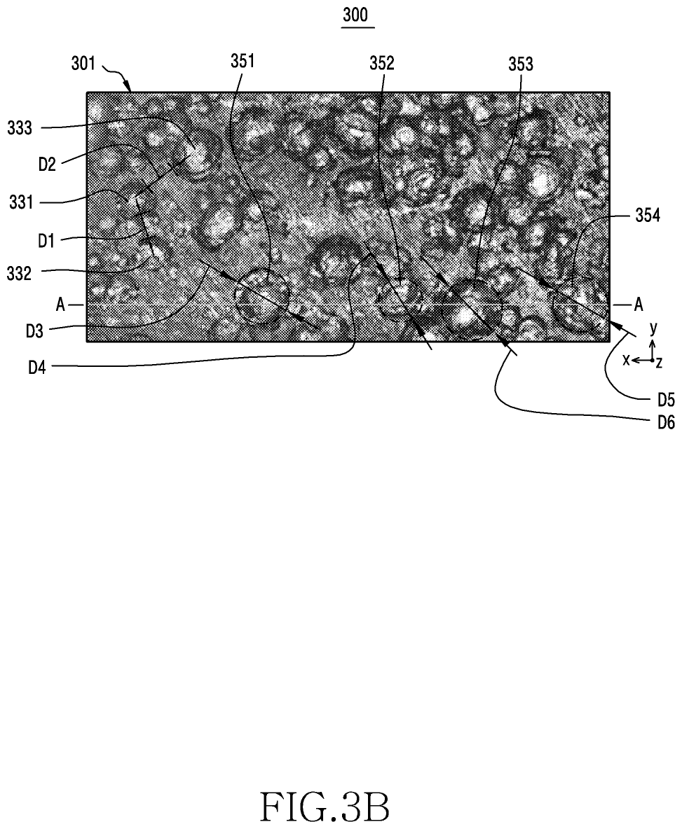

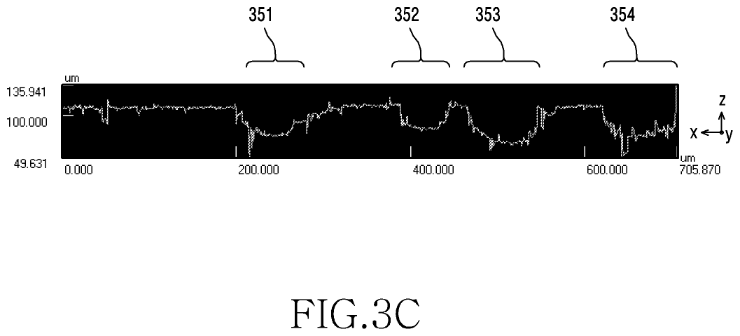

FIG. 3A is a diagram of an electron micrograph, according to an embodiment. FIG. 3A illustrates an electron micrograph with a magnification of 20,000 with respect to a surface 301 of a stainless steel member 300 prepared by performing surface treatment (e.g., electrolytic etching, rinsing, and drying).

Referring to FIG. 3A, the surface 301 of the stainless steel member 300 may be constructed as a surface on which substantially uniform grains 311, 312, and 313 and grain boundaries 321, 322, and 323 are revealed. The grain boundaries 321, 322, and 323 may be defined as a portion or boundary at which the grains 311, 312, and 313 are met. The grains 311, 312, and 313 may have substantially hexagonal shapes. A shape, size, or the like of the grains and grain boundaries may be constructed differently depending on various processing conditions (e.g. a composition and concentration of the surface treatment liquid, a temperature, voltage and/or current of the surface treatment liquid, or the like) regarding the electrolytic etching.

FIG. 3B is a diagram of an electron micrograph, according to an embodiment. FIG. 3B illustrates an electron micrograph obtained with a magnification smaller than that of FIG. 3A with respect to the surface 301 of the stainless steel member 300 prepared by performing electrolytic etching, rinsing, and drying.

Referring to FIG. 3B, the surface 301 of the stainless steel member 300 may include a concave-convex surface on which a plurality of pits (or recesses) of a concave shape are constructed substantially irregularly across the entirety of the surface. A gap D1 between any one first pit 331 and its neighboring second pit 332 may differ from a gap D2 between the first pit 331 and its neighboring third pit 333. Even if the D1 between the first pit 331 and the second pit 332 and the gap D2 between the first pit 331 and the third pit 333 are within a configured range, at least one of the first pit 331, the second pit 332, and the third pit 333 may have a shape different from the others.

FIG. 3C is a diagram of a graph, according to an embodiment. FIG. 3C illustrates a cross-sectional curve for a portion corresponding to the line A-A of FIG. 3B, in regards to surface roughness.

Referring to FIGS. 3B and 3C, from a cross-sectional view, a plurality of pits 351, 352, 353, and 354 may include a rounded or hemispherical space which is substantially concave in a z-axis direction. The rounded or hemispherical space of the plurality of pits 351, 352, 353, and 354 may have substantially diameters D3, D4, D5, and D6 less than or equal to about 200 um or depths less than or equal to about 100 um.

Referring to FIG. 3B, the surface 301 of the stainless steel member 300 prepared by performing electrolytic etching, rinsing, and drying may have an average concave-convex spacing Rsm of about 50˜200 um, or may have a ten point average roughness Rz of about 20˜150 um.

At least part of the plurality of pits 351, 352, 353, and 354 may be constructed in different shapes. At least one of the plurality of pits 351, 352, 353, and 354 may have a width different from those of the others in an x-axis direction or a y-axis direction. At least one of the plurality of pits 351, 352, 353, and 354 may have a depth different from those of the others in a z-axis direction.

The plurality of pits and the surface roughness based thereon may be constructed differently depending on various processing conditions (e.g., a composition and concentration of the surface treatment liquid, a temperature, voltage, and/or current of the surface treatment liquid, or the like) regarding the electrolytic etching.

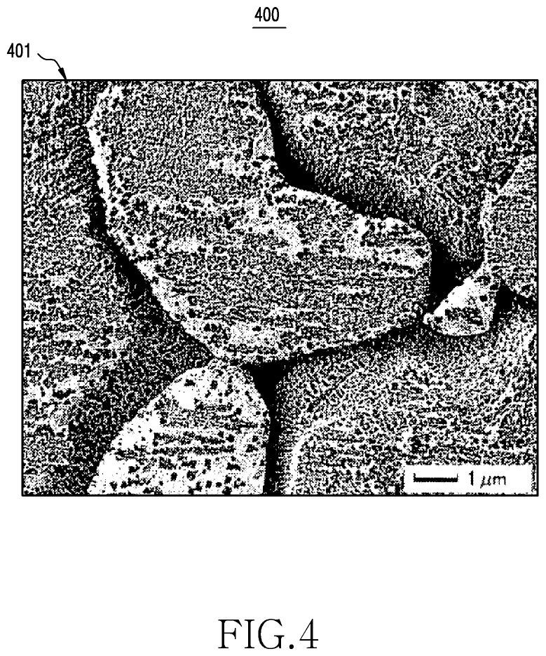

FIG. 4 is a diagram of an electron micrograph, according to an embodiment. FIG. 4 illustrates an electron micrograph with a magnitude of 10,000 with respect to a surface 401 of a stainless steel member 400 which obtains stainless steel by utilizing an aqueous sulfuric acid solution. Compared with a surface of a stainless steel member (e.g., see FIG. 3B) subjected to electrolytic etching by utilizing the aqueous sulfuric acid solution mixed with a chlorinated compound, the surface 401 of the stainless steel member of FIG. 4 may have irregular grains and grain boundaries. Compared with the electrolytic etching which utilizes surface treatment liquid obtained by mixing a chloride compound and sulfuric acid, when the stainless steel is subjected to the electroless etching by utilizing the aqueous sulfuric acid solution, sulfuric acid having a relatively high processing temperature (e.g., at least 80° C.) and a relatively high concentration may be necessary in order to corrode the surface while overcoming corrosion resistance of the stainless steel. Accordingly, when the stainless steel is subjected to the electroless etching by utilizing the aqueous sulfuric acid solution, sulfuric acid gas may be vaporized due to a high temperature, and the sulfuric acid gas may corrode facilities or make it difficult to ensure safety of operators. The electrolytic etching which utilizes the surface treatment liquid obtained by mixing the chloride compound (e.g., iron chloride) and the sulfuric acid may provide a safe operational environment as well as making it easy to install and maintain the facilities.

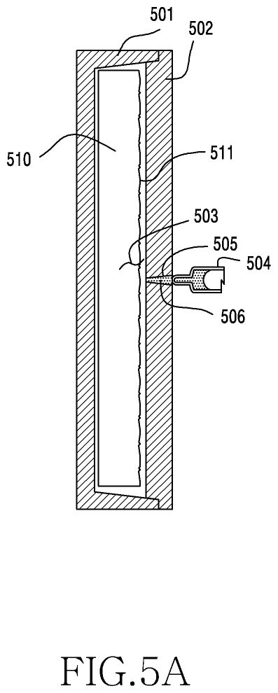

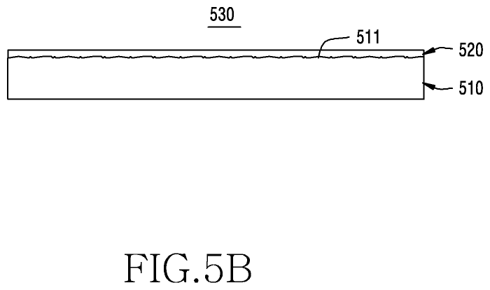

Referring back to FIG. 1, at step 107, an injection may be performed to join resin to a stainless steel member prepared by performing surface treatment (e.g., electrolytic etching, rinsing, and drying). FIG. 5A is a diagram of a molding process, according to an embodiment. FIG. 5A is a view illustrating an injection in which resin is joined to a stainless steel member. FIG. 5B is a diagram of a composite, according to an embodiment. FIG. 5B is a cross-sectional view illustrating a composite of resin and stainless steel.

Referring to FIG. 5A, molds 501 and 502 may include the cavity retainer plate 501 having an empty space (e.g., cavity) which is made to be concave so that molten resin is introduced and the core retainer plate 502 having a core. After the core retainer plate 502 and the cavity retainer plate 501 are bonded so that a stainless steel member 510 is disposed to a space 503 consisting of the cavity and the core, an ejector 504 may allow molten resin 506 to be introduced to the space 503 through a nozzle 505 of the core retainer plate 502. The molten resin 506 introduced to the space 503 may be closely in contact with a surface 511 of the stainless steel member 510 while being filled in the space 503.

Referring to FIGS. 5A and 5B, when the core retainer plate 502 is separated from the cavity retainer plate 501 after cooling water is circulated through the molds 501 and 502, a composite 530 joined to the resin member 530 and the stainless steel member 510 may be constructed. As such, a method of putting the stainless steel member 510 into the molds 501 and 502, injecting the molten resin to construct a resin member 520, and joining the resin member 520 and the stainless steel member 510 may be defined as injection joining

The surface 511 of the stainless steel member 510 prepared by performing surface treatment may include a concave-convex surface 301 on which a plurality of pits of a concave shape are constructed substantially irregularly across the entirety of the surface. The surface 511 of the stainless steel member 510 prepared by performing surface treatment may include substantially uniform grains and grain boundaries (e.g., see the concave-convex surface 301 of FIG. 3A). The surface 511 may increase bonding force (or mechanical bonding force) between the stainless steel member 510 and the resin member 520. As such, an effect of mechanical bonding between the stainless steel member 510 and the resin member 520 due to resin which is solidified by entering to a fine concave-convex portion of the surface 511 of the stainless steel member 510 may be referred to as an anchor effect.

The molten resin utilized in the injection may have fluidity (e.g., modulus of less than or equal to about 105 pa) so as to be filled on the concave-convex surface 511 of the stainless steel member 510 without any empty spaces.

The resin member 520 may include at least one resin out of polyalkyleneterephthalate and a copolymer consisting mainly of polyalkyleneterephthalate.

The resin member 520 may include a variety of other thermoplastic resin. For example, the resin member 520 may include at least one resin out of polyphthalamide, polyamide, polybutyleneterephthalate, polyacetal, polycarbonate, polyimide, polyphehyleneoxide, polysulfone, polyphenylenesulfide, polyethersulfone, liquid crystal polymer, polythezrketone, polyetheretherketone, polyetherimide, polyolefin, polystyren), and syndiotactic polystyrene. In addition, the resin member 520 may be constructed of various polymers or prepregs.

The resin member 520 may be constructed of resin having a property (e.g., joining affinity) of being reliably joined to the stainless steel.

An organic adhesive layer such as a sealant disposed between the stainless steel member 510 and the resin member 520 may be further included. The organic adhesive layer may include triazine thiol, dithio threitol, a silane-based compound, or the like.

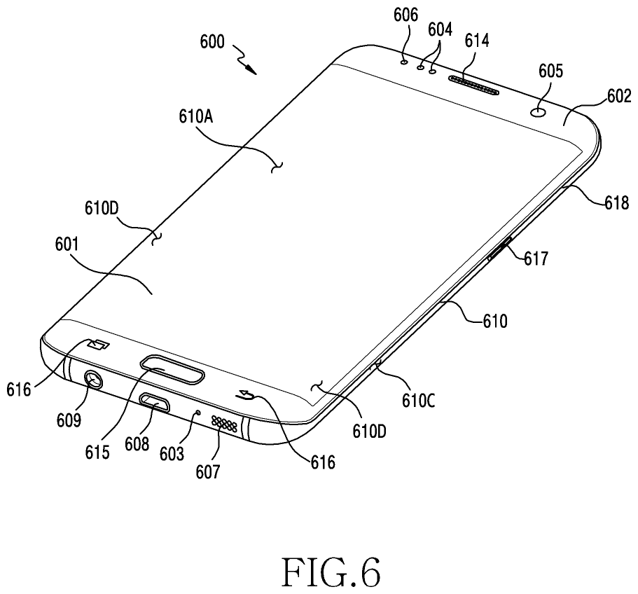

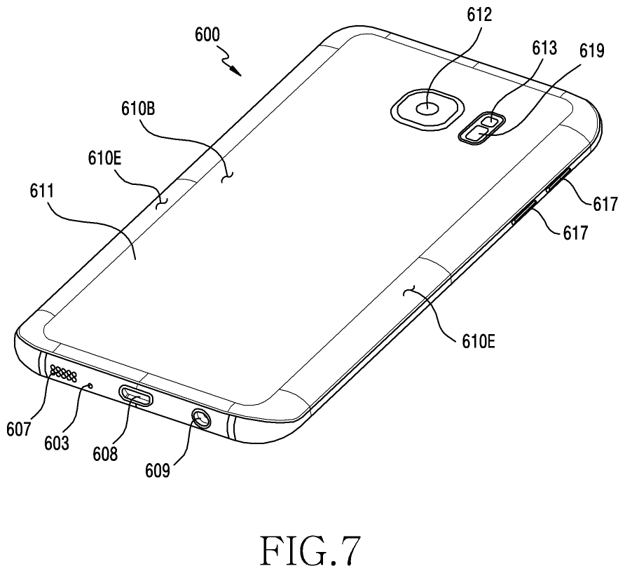

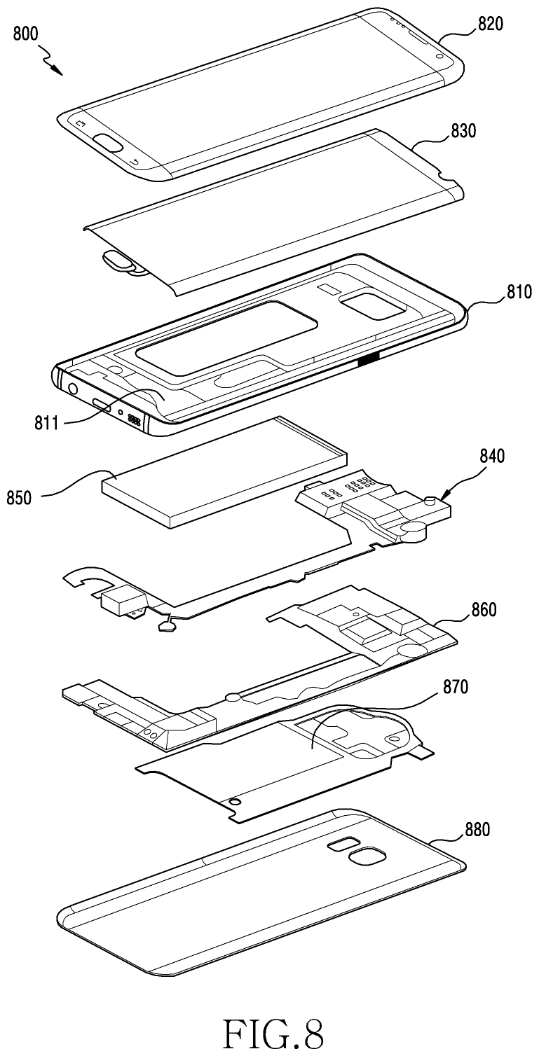

FIGS. 6, 7 and 8 are diagrams of an electronic device including a composite of stainless steel and resin, according to an embodiment. FIG. 6 is a front perspective view of an electronic device including a composite of stainless steel and resin. FIG. 7 is a rear perspective view of the electronic device. FIG. 8 is an exploded perspective view of the electronic device.

Referring to FIGS. 6 and 7, an electronic device 600 may include a housing 610 including a first face (or a front face) 610A, a second face (or a rear face) 610B, and a side face 610C surrounding a space between the first face 610A and the second face 610B. The housing may refer to a structure which constitutes part of the first face 610A, second face 610B, and third face 610C of FIG. 6. The first face 610A may be constructed of a front plate 602 (e.g., a polymer plate or a glass plate having various coating layers) which is at least partially transparent substantially. The second face 610B may be constructed of a rear plate 611 which is opaque substantially. The rear plate 611 may be constructed of coated or colored glass, ceramic, polymer, metallic materials (e.g. aluminum, stainless steel (STS), or magnesium) or a combination of at least two of the these materials. The side face 610C may be constructed of a side bezel structure (or a side member) 618 bonded to the front plate 602 and the rear plate 611 and including metal and/or polymer. The rear plate 611 and the side bezel structure 618 may be constructed integrally and may include the same material (e.g., a metallic material such as aluminum).

The front plate 602 may include two first regions 610D seamlessly extended by being bent from the first face 610A toward the rear plate 611 at both ends of a long edge of the front plate 602. The rear plate 611 may include two second regions 610E seamlessly extended by being bent from the second face 610B toward the front plate 602 at both ends of a long edge. The front plate 602 (or the rear plate 611) may include only one of the first regions 610D (or the second regions 610E). Some of the first regions 610D or the second regions 610E may not be included. In a side view of the electronic device 600, the side bezel structure 618 may have a first thickness (or width) at a side in which the first regions 610D or the second regions 610E is not included, and may have a second thickness thinner than the first thickness at a side in which the first regions 610E or the second regions 610E is included.

The electronic device 600 may include at least one of a display 601, audio modules 603, 607, and 614, sensor modules 604 and 619, camera modules 605, 612, and 613, key input devices 615, 616, and 617, an indicator 606, and connector holes 608 and 609. The electronic device 600 may omit at least one of components (e.g., the key input devices 615, 616, and 617, or the indicator 606), or other components may be additionally included.

The display 601 may be exposed through some portions of the front plate 602. At least part of the display 601 may be exposed through the first face 610A and the front plate 602 constructing the first regions 610E of the side face 610C. The display 601 may be disposed adjacent to or bonded to a touch sensing circuit, a pressure sensor capable of measuring touch strength (pressure), and/or a digitizer for detecting a magnetic-type stylus pen. At least part of the sensor modules 604 and 619 and/or at least part of the key input devices 615, 616, and 617 may be disposed to the first regions 610D and/or the second regions 610E.

The audio modules 603, 607, and 614 may include the microphone hole 603 or the speaker holes 607 and 614. A microphone for acquiring external sound may be disposed inside the microphone hole 603. A plurality of microphones may be disposed to detect a direction of the sound. The speaker holes 607 and 614 may include the external speaker hole 607 and the receiver hole 614 for a call. The speaker holes 607 and 614 and the microphone hole 603 may be implemented as one hole, or a speaker (e.g., a Piezo speaker) may be included without the speaker holes 607 and 614.

The sensor modules 604 and 619 may generate an electrical signal or data value corresponding to an internal operational state of the electronic device 600 or an external environmental state. The sensor modules 604 and 619 may include the first sensor module 604 (e.g., a proximity sensor) and/or second sensor module (e.g., a fingerprint sensor) disposed to the first face 610A of the housing 610, and/or the third sensor module 619 (e.g., a heart rate monitoring (HRM) sensor) disposed to the second face 610B of the housing 610. The fingerprint sensor may be disposed not only to the first face 610A but also the second face 610B of the housing 610. The electronic device 600 may further include at least one of senor modules, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, and an illuminance sensor.

The camera modules 605, 612, and 613 may include the first camera module 605 disposed to the first face 610A of the electronic device 600, the second camera module 612 disposed to the second face 610B, and/or the flash 613. The camera module 605 and 612 may include one or more lenses, an image sensor, and/or an image signal processor. The flash 613 may include a light emitting diode (LED) or a xenon lamp. Two or more lenses (infrared cameras, wide angle and telephoto lenses) and image sensors may be disposed to one face of the electronic device 600.

The key input devices 615, 616, and 617 may include the home key button 615 disposed to the first face 610A of the housing 610, the touch pad 616 disposed around the home key button 615, and/or the side key button 617 disposed to the side face 610C of the housing 610. The electronic device 600 may not include some or all of the aforementioned key input devices 615, 616, and 617. The key input devices 615, 616, and 617, which are not included, may be implemented on a display 601 in a different form such as a soft key or the like.

The indicator 606 may be disposed to the first face 610A of the housing 610. The indicator 606 may provide, for example, state information of the electronic device 600 in an optical form, and may include an LED.

The connector holes 608 and 609 may include the first connector hole 608 capable of accommodating a connector (e.g., a USB connector) for transmitting/receiving power and/or data of an external electronic device and/or the second connector hole (e.g., earphone jack) 609 capable of accommodating a connector for transmitting/receiving an audio signal with respect to the external electronic device.

Referring to FIG. 8, an electronic device 800 may include a side bezel structure 810, a first support member 811 (e.g., a bracket), a front plate 820, a display 830, a printed circuit board (PCB) 840, a battery 850, a second support member 860 (e.g., a rear case), an antenna 870, and a rear plate 880. The electronic device 800 may omit at least one (e.g., the first support member 811 or the second support member 860) of these components, or may additionally include other components. At least one of the components of the electronic device 800 may be the same as or similar to at least one of the components of the electronic device 600 of FIG. 6 or FIG. 7, and redundant descriptions will be omitted hereinafter.

The first support member 811 may be coupled with the side bezel structure 810 by being disposed inside the electronic device 800, or may be integrated with the side bezel structure 810. The first support member 811 may be constructed of a metal material and/or a non-metal (e.g., polymer) material. The first support member 811 may have the display 830 coupled to one face and the PCB 840 coupled to the other face. A processor, a memory, and/or an interface may be mounted on the PCB 840. The processor may include one or more of a central processing unit, an application processor, a graphic processing unit, an image signal processor, a sensor hub processor, and a communication processor.

The memory may include a volatile memory or a non-volatile memory.

The interface may include, for example, a high-definition multimedia interface (HDMI), a USB interface, an SD card interface, and/or an audio interface. The interface may electrically or physically couple the electronic device 800 with an external electronic device, and may include a USB connector, an SD card/MMC connector, or an audio connector.

The battery 850 may be a device for supplying power to at least one component of the electronic device 800, and may include a primary cell which is not rechargeable, a secondary cell which is rechargeable, or a fuel cell. At least part of the battery 850 may be disposed to be substantially co-planar with the PCB 840. The battery 850 may be disposed inside the electronic device 800, and may be disposed to be detachable from the electronic device 800.

The second support member 860 may be bonded to the first support member 811, and may be disposed between the PCB 840 and the rear plate 880. The second support member 860 may be bonded to the first support member 811 through bolt fastening or the like together with the PCB 840, and may cover the PCB 840 to protect it.

The antenna 870 may be disposed between the rear plate 880 and the battery 850. The antenna 870 may include, for example, a near field communication (NFC) antenna, a wireless charging antenna, and/or a magnetic secure transmission (MST) antenna. The antenna 870 may perform short-range communication with the external electronic device, or may wirelessly transmit/receive power required for charging. An antenna structure may be constructed by at least part of the side bezel structure 810 and/or the first support member 811 or a combination thereof.

At least one of the side bezel structure 810 and the rear plate 880 may include a composite (e.g., the composite 530 of FIG. 5B) of stainless steel and resin, which is constructed through the flow of the manufacturing method of FIG. 1. The composite of the stainless steel and the resin, which is constructed through the flows of the manufacturing method of FIG. 1, may also be applied to various other parts of the electronic device 300.

The composite of stainless steel and resin, which is constructed through the flow of the manufacturing method of FIG. 1, may be utilized as at least some external or internal components of various constructions other than the electronic device.

According to an embodiment, a composite may include stainless steel of which a concave-convex surface is constructed through electrolytic etching, and resin bonded to the concave-convex surface.

A surface treatment liquid in which sulfuric acid and at least one chlorinated compound are mixed may be utilized in the electrolytic etching.

The concave-convex surface may have either an average concave-convex spacing Rsm of about 50˜200 um or a ten point average roughness Rz of about 20˜150 um.

A plurality of pits having either a diameter less than or equal to about 200 um or having a depth less than or equal to about 100 um may be irregularly constructed on the concave-convex surface.

The concave-convex surface may include uniform grains and grain boundaries.

The stainless steel may include STS316L.

The resin may include at least one of polyalkyleneterephthalate, polyphthalamide, polyamide, polybutyleneterephthalate, polyacetal, polycarbonate, polyimide, polyphehyleneoxide, polysulfone, polyphenylenesulfide, polyethersulfone, liquid crystal polymer, polythezrketone, polyetheretherketone, polyetherimide, polyolefin, polystyrene, and syndiotactic polystyrene.

According to an embodiment of the disclosure, a method of manufacturing the composite may include constructing a concave-convex surface by performing electrolytic etching on stainless steel, and joining resin to the concave-convex surface.

A surface treatment liquid in which sulfuric acid and at least one chlorinated compound are mixed may be utilized in the electrolytic etching.

The chlorinated compound may have a concentration of about 10˜100 g/L.

The sulfuric acid may have a concentration of about 50˜300 g/L.

The electrolytic etching may utilize current density of about 0.5˜5 A/dm2.

The electrolytic etching may be performed at about 30˜70° C.

The concave-convex surface may have either an average concave-convex spacing Rsm of about 50˜200 um or have a ten point average roughness Rz of about 20˜150 um.

A plurality of pits having either a diameter less than or equal to about 200 um or a depth less than or equal to about 100 um may be irregularly constructed on the concave-convex surface.

The stainless steel may include STS316L.

The resin may include at least one of polyalkyleneterephthalate, polyphthalamide, polyamide, polybutyleneterephthalate, polyacetal, polycarbonate, polyimide, polyphehyleneoxide, polysulfone, polyphenylenesulfide, polyethersulfone, liquid crystal polymer, polythezrketone, polyetheretherketone, polyetherimide, polyolefin, polystyrene, and syndiotactic polystyrene.

The method may further include removing foreign matter constructed on the concave-convex surface.

Removing the foreign matter constructed on the concave-convex surface may utilize ultrasonic cleaning

According to an embodiment of the disclosure, a surface treatment method of stainless steel may include constructing surface treatment liquid in which sulfuric acid and at least one chlorinated compound are mixed, and performing electrolytic etching on the stainless steel by utilizing the surface treatment liquid. The chlorinated compound may have a concentration of about 10˜100 g/L. The sulfuric acid may have a concentration of about 50˜300 g/L. The electrolytic etching may utilize current density of about 0.5˜5 A/dm2.

The electrolytic etching may be performed at about 30˜70° C.

Various exemplary embodiments of the disclosure disclosed in the specification and the drawings are merely specific examples presented for clarity and are not intended to limit the scope of the disclosure. Therefore, in addition to the embodiments disclosed herein, various changes in forms and details made without departing from the technical concept of the disclosure will be construed as being included in the scope of the disclosure.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an ASIC.

Various embodiments of the present disclosure may be implemented by software including an instruction stored in a machine-readable storage media readable by a machine (e.g., a computer). The machine may be a device that calls the instruction from the machine-readable storage media and operates depending on the called instruction and may include the electronic device. When the instruction is executed by the processor, the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. A composite, comprising:
stainless steel of which a concave-convex surface is constructed through electrolytic etching; and
resin joined to the concave-convex surface.

2. The composite of claim 1, wherein surface treatment liquid in which sulfuric acid and at least one chlorinated compound are mixed is utilized in the electrolytic etching.

3. The composite of claim 1, wherein the concave-convex surface has either an average concave-convex spacing Rsm of about 50˜200 um, or a ten point average roughness Rz of about 20˜150 um.

4. The composite of claim 1, wherein a plurality of pits having either a diameter less than or equal to about 200 um or a depth less than or equal to about 100 um are irregularly constructed on the concave-convex surface.

5. The composite of claim 1, wherein the concave-convex surface comprises uniform grains and grain boundaries.

6. The composite of claim 1, wherein the stainless steel comprises STS316L.

7. The composite of claim 1, wherein the resin comprises at least one of polyalkyleneterephthalate, polyphthalamide, polyamide, polybutyleneterephthalate, polyacetal, polycarbonate, polyimide, polyphehyleneoxide, polysulfone, polyphenylenesulfide, polyethersulfone, liquid crystal polymer, polythezrketone, polyetheretherketone, polyetherimide, polyolefin, polystyrene, and syndiotactic polystyrene.

8. A method of manufacturing a composite, the method comprising:
constructing a concave-convex surface by performing electrolytic etching on stainless steel; and
joining resin to the concave-convex surface.

9. The method of claim 8, wherein surface treatment liquid in which sulfuric acid and at least one chlorinated compound are mixed is utilized in the electrolytic etching.

10. The method of claim 9, wherein the chlorinated compound has a concentration of about 10˜100 g/L.

11. The method of claim 10, wherein the sulfuric acid has a concentration of about 50˜300 g/L.

12. The method of claim 8, wherein the electrolytic etching utilizes a current density of about 0.5˜5 A/dm2.

13. The method of claim 8, wherein the electrolytic etching is performed at about 30˜70° C.

14. The method of claim 8, wherein the concave-convex surface has either an average concave-convex spacing Rsm of about 50˜200 um, or a ten point average roughness Rz of about 20˜150 um.

15. The method of claim 8, wherein a plurality of pits having either a diameter less than or equal to about 200 um or having a depth less than or equal to about 100 um are irregularly constructed on the concave-convex surface.

16. The method of claim 8, wherein the stainless steel comprises STS316L.

17. The method of claim 8, wherein the resin comprises at least one of polyalkyleneterephthalate, polyphthalamide, polyamide, polybutyleneterephthalate, polyacetal, polycarbonate, polyimide, polyphehyleneoxide, polysulfone, polyphenylenesulfide, polyethersulfone, liquid crystal polymer, polythezrketone, polyetheretherketone, polyetherimide, polyolefin, polystyrene, and syndiotactic polystyrene.

18. The method of claim 8, further comprising removing foreign matter constructed on the concave-convex surface.

19. A surface treatment method of stainless steel, the method comprising:
constructing surface treatment liquid in which sulfuric acid and at least one chlorinated compound are mixed; and
performing electrolytic etching on the stainless steel by utilizing the surface treatment liquid,
wherein the chlorinated compound has a concentration of about 10˜100 g/L,
wherein the sulfuric acid has a concentration of about 50˜300 g/L, and
wherein the electrolytic etching utilizes a current density of about 0.5˜5 A/dm2.

20. The method of claim 19, wherein the electrolytic etching is performed at about 30˜70° C.
